(19) United States
(12) Patent Application Publication
(10) Pub. No.: US 2025/0139329 A1
(43) Pub. Date: May 1, 2025

(54) TWO-DIMENSIONAL CONTINUOUS-DISCONTINUOUS COMBINED NUMERICAL APPROACH FOR SOLID FRACTURING SIMULATION

(71) Applicant: SOUTHERN UNIVERSITY OF SCIENCE AND TECHNOLOGY, Shenzhen, Guangdong (CN)

(72) Inventors: Ke GAO, Shenzhen (CN); Weibing CAI, Shenzhen (CN)

(73) Assignee: SOUTHERN UNIVERSITY OF SCIENCE AND TECHNOLOGY, Shenzhen, Guangdong (CN)

(21) Appl. No.: 18/262,747

(22) PCT Filed: Aug. 5, 2022
(86) PCT No.: PCT/CN2022/110399

§ 371 Date: Jul. 25, 2023

(30) Foreign Application Priority Data
Jul. 18, 2022 (CN) 202210839079.1

(51) Int. Cl. G06F 30/23; G06F 111/10; G06F 119/14

(52) U.S. Cl. CPC G06F 30/23; G06F 2111/10; G06F 2119/14

(57) ABSTRACT

A two-dimensional continuous-discontinuous combined numerical approach for solid fracturing simulation, which includes: discretizing two-dimensional solid into finite elements to obtain a mapping linked list relationship between master-slave nodes; determining whether a crack is initiated according to whether the local stress of the finite element satisfies a strength criterion; if a crack initiates, activating a corresponding pre-embedded cohesive element, updating the mapping linked list relationship between the master-slave nodes at the same time, the cohesive element at the crack enters a yield state, and the mechanical behavior thereof is controlled by a strain softening constitutive curve; and, according to the mapping linked list relationship between the master-slave nodes, accumulating node forces and masses of the slave nodes onto the master node, and updating the velocity and the displacement of the master-slave nodes by adopting a governing equation.

### TECHNICAL FIELD

The present application relates to the technical field of rock mechanics, solid mechanics and material science, in particular to a two-dimensional continuous-discontinuous combined numerical approach for solid fracturing simulation.

### BACKGROUND

As a powerful complement to analytical and experimental methods, numerical simulations, owing to their rapidity and convenience, have been extensively employed to investigate the fracturing mechanism of solids on an engineering scale. Generally, numerical approaches for such analysis can be classified into three categories, i.e., continuum-based, discontinuum-based, and hybrid (combination of continuum- and discontinuum-based approaches).

The combined finite-discrete element method has been proposed by Munjiza as a typical hybrid approach (i.e., a discontinuous combined finite-discrete element method, dFDEM), where finite elements are employed to accurately capture the deformation within the solid domain, and cohesive elements are utilized to simulate the initiation and propagation of cracks. Because the finite elements and the cohesive elements are implemented using different types of constitutive laws, thereby may cause strain incompatibility even in the elastic deformation stage. Also, due to the early participation of cohesive elements from the beginning of the simulation, the conventional dFDEM may produce an artificial compliance problem and result in the overlap of neighboring finite elements. To alleviate such an artificial compliance problem, contact algorithms have to be incorporated to enhance the stability and accuracy of the numerical model, which no doubt increases computational costs.

To overcome the deficiencies in conventional dFDEM, Fukuda et al. have improved FDEM to cFDEM (continuous-FDEM) by adaptively inserting cohesive elements between adjacent finite elements when local stresses of the finite elements meet the specific fracturing criterion, and updating topology information through a node splitting scheme. However, such adaptive insertion of cohesive elements during the simulation is very challenging, which requires a robust splitting of local nodes between adjacent finite elements. Furthermore, the local node splitting scheme cannot be straightforwardly achieved, especially in 3D simulations, due to the more complicated spatial topological connection between finite elements, and it can also introduce considerable computation overhead. The complexity of the node splitting scheme in such FDEM realization could also increase the difficulty in code parallelization.

Therefore, the current technology requires significant improvement and development.

### SUMMARY

According to the aforementioned deficiencies in the previous work, the present application provides a novel two-dimensional continuous-discontinuous combined method for simulating solid fracturing processes, which aims to overcome the artificial compliance problem and the mutual overlap between the adjacent finite elements. Of particular concern is the challenge associated with the frequent updating of element topology during solid fracturing simulation, which leads to difficulties in numerical implementation and unstable calculations.

The technical solution of the present application to solve the technical problems is as follows:

In the first aspect, an embodiment of the present application provides a two-dimensional continuous-discontinuous combined solid fracturing simulation method. The method encompasses the following steps:
obtaining a two-dimensional solid, discretizing the two-dimensional solid into finite elements to obtain a mapping linked list relationship between master-slave nodes;
determining whether a crack is initiated according to whether local stress of the finite element satisfies a strength criterion;
if the crack is initiated, updating the mapping linked list relationship between the master-slave nodes, obtaining an updated mapping linked list relationship between the master-slave nodes, activating a corresponding pre-embedded cohesive element, and controlling a mechanical behavior of the cohesive element by adopting a corresponding strain softening constitutive curve;
according to the updated mapping linked list relationship between the master-slave nodes, accumulating nodal forces and masses of the slave nodes onto the master node, updating a velocity and a displacement of the master-slave nodes based on a governing equation, and re-executing the step of determining whether the crack is initiated according to whether the local stress of the finite element satisfies a strength criterion until a simulation is completed, and end a calculation.

In an implementation, the discretizing the two-dimensional solid into finite elements to obtain the mapping linked list relationship between the master-slave nodes comprises:
dividing the two-dimensional solid into a plurality of finite elements;
discretizing the finite elements, connecting adjacent finite elements through the cohesive elements, and mapping each corresponding finite element node into an independent slave node;
binding the slave nodes to a corresponding master node by adopting a node binding scheme, and connecting the slave nodes sequentially to obtain the mapping linked list relationship between the master-slave nodes.

In an implementation, the determining whether the crack is initiated according to whether the local stress of the finite element satisfies a strength criterion comprises:
calculating the local stress of the finite element according to a deformation gradient and a constitutive equation of the finite element;
determining that the finite element has a tensile crack initiated if the local stress of the finite element reaches a tensile strength;
determining that the finite element has a shear crack initiated if the local stress of the finite element reaches a shear strength;
determining that no crack is initiated if the local stress of the finite element does not reach the tensile strength or the shear strength.

In an implementation, the if the crack is initiated, updating the mapping linked list relationship between the master-slave nodes and obtaining the updated mapping linked list relationship between the master-slave nodes comprises:
removing a connection between two adjacent slave nodes at the crack if the crack is initiated;
re-obtaining a new master node for each of the slave nodes, and connecting the slave nodes having existing connections sequentially to obtain the updated master-slave node mapping linked list relationship between the master-slave nodes.

In an implementation, the activating the pre-embedded cohesive element in the crack, and controlling the mechanical behavior of the cohesive element by adopting the corresponding strain softening constitutive curve comprises:
activating the pre-embedded cohesive element in the crack to obtain a yield surface displacement component of the cohesive element;
simulating a yield behavior of the cohesive element according to the yield surface displacement component of the cohesive element and the corresponding strain softening constitutive curve.

In an implementation, the simulating the yield behavior of the cohesive element according to the yield surface displacement component of the cohesive element and the corresponding strain softening constitutive curve comprises:
inputting the yield surface displacement component of the cohesive element into the corresponding strain softening constitutive curve to obtain a cohesive element stress;
obtaining an equivalent force on a relevant node of the cohesive element according to the cohesive element stress to simulate the yield behavior of the crack.

In an implementation, the accumulating the node forces and the masses of the slave nodes onto the master node according to the updated mapping linked list relationship between the master-slave nodes, and updating the velocity and the displacement of the master-slave nodes by means of the governing equation, comprises:
accumulating the node forces and the masses of the slave nodes onto the master node according to the updated mapping linked list relationship between the master-slave nodes to obtain a node force and a mass of the master node;
updating the velocity and the displacement of the master node through an explicit integration and a central difference, according to the node force of the master node and the mass of the master node;
obtaining the velocity and the displacement of the slave nodes corresponding to the master node according to the updated velocity and the updated displacement of the master node.

In the second aspect, an embodiment of the present application further provides a two-dimensional continuous-discontinuous combined solid fracturing simulation approach. The approach comprises:
a master-slave node mapping linked list relationship obtaining module, configured to obtain a two-dimensional solid and discretizing the two-dimensional solid into a plurality of finite elements to obtain a mapping linked list relationship between master-slave nodes;
a finite element fracture determining module, configured to determine whether a crack is initiated, according to whether local stress of the finite element satisfies a strength criterion;
a fracturing process simulation module, configured to update the mapping linked list relationship between the master-slave nodes, obtaining an updated mapping linked list relationship between the master-slave nodes, activating a corresponding pre-embedded cohesive element, and controlling a mechanical behavior of the cohesive element by adopting a corresponding strain softening constitutive curve, if the crack is initiated;
a finite element node force updating module, configured to accumulate node forces and masses of the slave nodes onto the corresponding master node according to the updated mapping linked list relationship between the master-slave nodes, updating velocities and displacements of the master-slave nodes by adopting a governing equation, and re-executing the function of the finite element fracture determining module, until a simulation is completed, and ending a calculation.

In the third aspect, an embodiment of the present application further provides a smart terminal. The smart terminal comprises a memory, a processor, and a two-dimensional continuous-discontinuous combined solid fracturing simulation program stored in the memory and capable of being run by the processor, and when the processor runs the two-dimensional continuous-discontinuous combined solid fracturing simulation program, a plurality of steps on the two-dimensional continuous-discontinuous combined solid fracturing simulation method is implemented as described above.

In the fourth aspect, an embodiment of the present application further provides a storage medium. The storage medium has one or a plurality of programs stored, and the one or the plurality of programs can be run by one or a plurality of processors to implement a plurality of steps on the two-dimensional continuous-discontinuous combined solid fracturing simulation method described above.

Benefits: compared to the existing work, the present application provides a two-dimensional continuous-discontinuous combined solid fracturing simulation method; the embodiment of the present application first establishes a mapping linked list relationship between the master-slave nodes during a two-dimensional solid fracturing process. By binding the slave nodes onto the master nodes correspondingly through the mapping linked list relationship between the master-slave nodes, it is possible to achieve a completely continuous deformation for a solid domain in the elastic stage to ensure that no cohesive element is calculated before a crack is initiated, and to avoid the artificial compliance problem. When a crack is initiated, the cohesive element is invoked, so as to control the mechanical behavior of the cohesive element by a strain softening constitutive curve, and update the mechanical behavior of the cohesive element. In the whole process, it is not required to update the topological relation between model elements and the nodes, which not only dramatically improves the calculation efficiency, but also can avoid the numerical instability induced by node splitting when solid fracturing occurs.

### BRIEF DESCRIPTION OF THE DRAWINGS

In order to provide a more precise explanation of the embodiments of the present application or the technical solutions, a brief introduction will be given to the accompanying drawings used in the description of the embodiments. It is evident that the accompanying drawings described below are merely some embodiments recorded in the present application. Ordinary skilled persons in the field can obtain additional drawings based on these drawings without creative effort.

FIG. 1 illustrates a schematic flowchart on a two-dimensional continuous-discontinuous combined solid fracturing simulation method according to an embodiment of the present application.

FIG. 2 illustrates a schematic diagram of a mapping linked list relationship between master-slave nodes according to an embodiment of the present application.

FIG. 3 illustrates a schematic diagram of a process for updating a mapping linked list relationship between the master-slave nodes according to an embodiment of the present application.

FIG. 4 illustrates a schematic diagram of a strain-softening constitutive curve of the cohesive element according to an embodiment of the present application

FIG. 5 illustrates a schematic block diagram on a two-dimensional continuous-discontinuous combined solid fracturing simulation approach according to an embodiment of the present application

FIG. 6 illustrates a principle block diagram on an internal structure of a smart terminal according to an embodiment of the present application

### DETAILED DESCRIPTION OF EMBODIMENTS

In order to make the goal, technical solution and advantages of the present application more clear and precise, the following embodiments are provided as further detailed explanations of the present application with reference to the accompanying drawings. It should be understood that the specific embodiments described herein are only used to explain the present application and should not be construed as limiting the scope of the application.

In the prior art, because cohesive elements participate in the calculation in the elastic stage, an artificial compliance problem is generated, and a mutual overlap between adjacent finite elements may occur. At the same time, an adaptive embedding of cohesive elements requires a dynamic splitting on local nodes between adjacent finite elements, which will increase the calculation cost significantly and reduce the calculation stability.

In order to solve the problems in the prior art, the present embodiment provides a two-dimensional continuous-discontinuous combined solid fracturing simulation method, which comprises: firstly, discretizing a solid medium into independent finite elements, and adopting a node binding scheme to bind adjacent finite elements in a master-slave manner; when local stress of the finite element meets a fracture criterion, activating a cohesive element pre-embedded between adjacent finite elements, then controlling the mechanical behavior of the cohesive element by means of a strain softening constitutive curve. At the same time, updating a mapping linked list relationship between master-slave nodes dynamically. Finally, after the crack is generated, to avoid a mutual overlap between the finite elements on both sides of the crack, a contact calculation algorithm is employed between the finite elements before achieving a complete simulation of a solid dynamic fracturing process from continuum to discontinuum. The technology provided by the present application can not only ensure that a solid medium is completely continuous prior to fracture onset, but also avoid problems including the difficulty in numerical implementation, an unstable calculation and more, caused by continuously updating element topology when simulating a solid fracturing in traditional methods. The calculation efficiency of the solid fracturing simulation can also be effectively improved.

### Embodiments on the Method

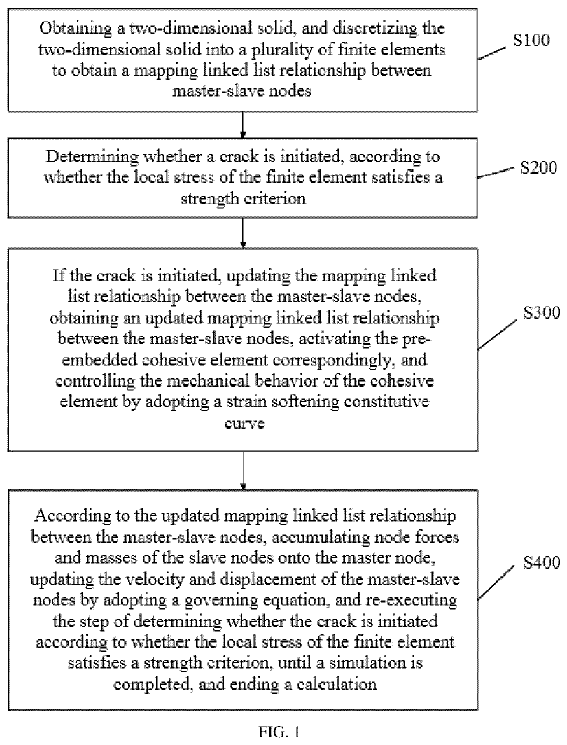

The present embodiment provides a two-dimensional continuous-discontinuous combined solid fracturing simulation method, which can be applied to a fracture simulation approach. As shown in FIG. 1, the method comprises the following steps:

Step S100, obtaining a two-dimensional solid and discretizing the two-dimensional solid into a plurality of finite elements to obtain a mapping linked list relationship between master-slave nodes.

In the numerical simulation of two-dimensional solid fracturing process, a continuous method is configured to simulate elastic stage. The continuous method is selected from an extended finite element method, a boundary element method, a material point method, a phase field dynamic and peridynamic method, which can capture the elastoplastic damage problem of the solid material well. The present embodiment captures the deformation of a two-dimensional solid by discretizing the solid medium into independent finite elements, to implement a simulation of an elastic process by a continuous method.

The finite elements are limited non-overlapped elements generated by discretizing the two-dimensional solid, and have become a powerful tool for solving problems in rock mechanics and solid mechanics. Through the finite elements, it is possible to take continuum mechanics as a basis, taking account of a continuity of a substance, a continuity of a physical and mechanical property of a medium and a continuity of a mechanical reaction. The solid material is regarded as a continuum under a certain condition or combined with a certain special element, to simulate the mechanical behavior of the solid material. The type of finite element mesh can be divided as a triangular mesh, a quadrilateral mesh, and a polygonal mesh. After discretizing the two-dimensional solid into finite elements, mapping a corresponding finite element node into an independent slave node, and connecting the slave nodes sequentially to obtain a mapping linked list relationship between master-slave nodes.

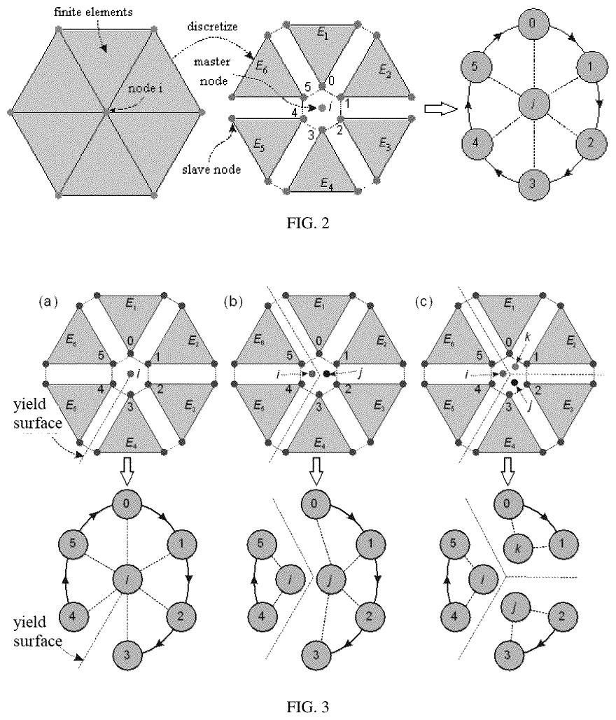

In an embodiment, shown as FIG. 2, step S100 in the present embodiment comprises the following steps:
Step S101, meshing the two-dimensional solid into a plurality of triangular finite elements;
Step S102, discretizing the finite elements, connecting adjacent finite elements through cohesive elements, and mapping each corresponding finite element node into an independent slave node;
Step S103, binding the slave node to a corresponding master node by adopting a node binding scheme, and connecting the slave nodes sequentially to obtain the mapping linked list relationship between the master-slave nodes.

Specifically, the present embodiment adopts a plurality of triangular finite elements to mesh the two-dimensional solid. After the triangular finite elements are discretized, adjacent finite elements are connected by a plurality of cohesive elements having four nodes and zero-thickness. The new topology information of both finite elements and cohesive elements is retained, and each finite element node is mapped to an independent slave node. In order to avoid artificial compliance problems existing in the elastic stage caused by the stiffness difference between the finite element and the cohesive element, the mapping linked list relationship between master-slave nodes is obtained by grouping the nodes and connecting the independent slave nodes sequentially, wherein the master-slave node are sharing the same coordinates and displacements. The cohesive element does not participate in the calculation during the elastic stage. In such a way, during the elastic deformation stage, it is ensured that each slave node in the same mapping linked list relationship between the master-slave nodes has the same mechanical behavior, that is, the slave nodes have the same velocity and displacement. The present method can achieve a continuous deformation before a crack starts for the two-dimensional solid.

In an embodiment, shown in FIG. 2, the two-dimensional solid is discretized into six finite elements, that is, E₁, E₂ . . . . E₆. A master node i, before the finite elements are discretized, corresponds to six independent slave nodes 0 to 5 after the finite elements are discretized, and the slave nodes 0 to 5 have the same coordinate as the master node i. The slave nodes 0 to 5 are bound to form a mapping linked list relationship between the master-slave nodes according to a spatial topological relationship, that is, 0→1→2→3→4→5→0; at the same time, the master node i is adopted to mark the slave nodes and the mapping information between each slave node and the master node i, that is, 0→i, 1→i, . . . , 5→i. In the elastic deformation stage, the slave nodes 0 to 5 have the same mechanical behavior as the master node i, that is, the slave nodes 0 to 5 have the same velocity and displacement as the master node i.

Step S200, determining whether a crack is initiated according to whether the local stress of the finite element satisfies a strength criterion.

In order to simulate the initiation and extension of a crack, a node force will be applied to the mapping linked list relationship between the master-slave nodes, to simulate the force condition of the two-dimensional solid. Whether a crack is initiated is determined according to whether the local stress of the finite element satisfies the strength criterion in the present embodiment.

In an implementation, the step S200 in the present embodiment comprises the following steps:
Step S201, calculating the local stress of the finite element according to a deformation gradient and a constitutive equation of the finite element;
Step S202, determining that the finite element has a tensile crack initiation if the local stress of the finite element reaches a tensile strength;
Step S203, determining that the finite element has a shear crack initiation if the local stress of the finite element reaches a shear strength;
Step S204, determining that no crack is initiated if the local stress of the finite element does not reach the tensile strength or the shear strength.

In the present embodiment, the shear fracture and the tensile fracture of the solid material are simulated by taking the Mohr-Coulomb and the maximum tensile stress criterion as an example. It should be noted that other crack criteria may be adopted and it is possible to replace the Mohr-Coulomb and the maximum tensile stress criterion according to an actual requirement.

A condition for setting the crack initiation is: when both the Cauchy stresses of the two adjacent finite elements resolved on their common edge satisfy the following conditions:

$$\{ \begin{matrix}{σ}_{n} < - {f}_{t} , & tensile fracture \\ {τ}_{s} > c + {σ}_{n} tan φ , & shear fracture\end{matrix}$$

where σₙ and τₛ are respectively the normal stress and tangential stress obtained by decomposing along a common edge, fₜ is the tensile strength of the material, c and φ represent respectively the cohesion and internal friction angle of the material. Here, compressive stress is considered positive, and tensile stress is negative.

Specifically, the normal stress σₙ and the tangential stress τₛ are obtained respectively by decomposing along the common edge of any two adjacent finite elements. When σₙ<−fₜ, it is determined that a tensile crack is initiated, and when τₛ>c+σₙ tan φ, it is determined that a shear crack is initiated.

Step S300, if the crack is initiated, updating the mapping linked list relationship between the master-slave nodes, obtaining an updated mapping linked list relationship between the master-slave nodes, activating the pre-embedded cohesive element correspondingly, and controlling the mechanical behavior of the cohesive element by adopting a strain softening constitutive curve.

Specifically, if a crack is initiated, the original mapping linked list relationship between the master-slave nodes will be updated to a plurality of new mapping relationships between the master-slave nodes. That is, obtaining a new master node and updating the mapping linked list between the master-slave nodes to ensure that the elastic deformation of the finite elements on both sides of the crack is independent. When the crack is initiated, the cohesive element enters a strain softening phase, that is, a discontinuous process. The present embodiment activates the cohesive element to dissipate fracture energy and captures strain-softening characteristics of material without activating the cohesive element prior to fracture onset to ensure a complete and continuous deformation of the solid domain in the elastic stage, avoiding the artificial compliance problem.

In an implementation, the step S300 in the present embodiment comprises the following steps:
Step S301, deleting connection between two adjacent slave nodes at the crack, if the crack is initiated;
Step S302, re-obtaining a new master node for each of the slave nodes, and connecting the slave nodes having existing connections, to obtain the updated master-slave node mapping linked list relationship.

Specifically, if the crack is initiated, it is necessary to update a node binding relationship correspondingly and obtain a new mapping linked list relationship between the master-slave nodes to ensure that elastic deformation of the finite elements located on both sides of the crack is independent. Each time by removing the connection between two adjacent slave nodes at the crack, it is possible to update the mapping linked list relationship between the master-slave nodes, and determine a new master node for the updated mapping linked list relationship between the master-slave nodes. Correspondingly, independent slave nodes are grouped automatically before being bound with the updated mapping linked list relationship between the master-slave nodes, and establishing a mapping relationship with the new master node. Each time, after updating the mapping linked list relationship between the master-slave nodes and the mapping relationship, the elastic deformation of the finite elements on a corresponding linked list is calculated according to the new mapping linked list relationship between the master-slave nodes, as well as accumulating node forces of the updated mapping linked list relationship between the master-slave nodes to the new master node correspondingly, to achieve an explicit separation for a fracture surface (strong discontinuity).

In an embodiment, shown in FIG. 3, once the cohesive element between elements E₄ and E₅ becomes a yield surface, the connection between the slave nodes 3 and 4 will be cut out, and the previous circular linked list becomes an open linked list 4→5→0→1→2→3, shown as FIG. 3a. At this time, the slave nodes 0 to 5 are still in the same group and mapped to the same master node i at this time, since the slave nodes are located at a fracture tip inside the model and have to be forced to displace together. As the model evolves and another cohesive element is invoked, for example, the connection between the slave nodes 0 and 5 will again be cut out, and the previous open linked list becomes two open linked lists, that is, 0→1→2→3 and 4→5 (FIG. 3b), the cohesive element between finite element E₆ and finite element E₁ is further activated. At this time, the slave nodes 0 to 5 are divided into two groups automatically before being mapped respectively to a master node j and a master node i (FIG. 3b). The node force on the master node j is integrated by the slave nodes 0-3, and the node force on the master node i is integrated by the slave nodes 4 and 5. By repeating the process stated above, it is possible to continue achieving the explicit separation of crack surfaces, and activate a calculation for the cohesive element. In an embodiment, a node connection between element E₂ and element E₃ shown in FIG. 3c is removed again, and a new mapping linked list relationship between the master-slave nodes 0→1, 2→3 and 4→5 is obtained. Slave node 1 and slave node 2 are separated into two groups automatically, and mapped to a master node k and a master node j, respectively. Each time after updating the node binding linked list and the mapping linked list, it is followed by using the new lists to calculate the elastic deformation of the finite elements in a corresponding group. Obviously, for the model shown in FIG. 3, the node binding scheme proposed is able to realize the explicit separation for the fracture surfaces (the strong discontinuity). In an embodiment, a crack will eventually be initiated between the finite elements E₄ and E₅, elements E₆ and E₁, as well as elements E₂ and E₃.

In an embodiment, the step S300 in the present embodiment comprises the following steps:
Step M301, activating the pre-embedded cohesive element to obtain a yield surface displacement component of the cohesive element;
Step M302, simulating the yield behavior of the crack according to the yield surface displacement component of the cohesive element and a corresponding strain softening constitutive curve.

Specifically, in order to simulate an initiation and an expansion of the crack, when local stress reaches the strength, by activating the cohesive element, a fracture energy is released and a strain-softening feature of a material is captured. When the cohesive elements between the finite elements are activated, to avoid mutual overlap between adjacent finite elements, a contact calculation will be started to further process the interaction between explicit fracture surfaces. The mechanical behavior of the cohesive element is controlled by a traction-separation law until a new crack is completely formed. In a strain softening stage, two edges (that is, a yield surface) of the cohesive element may generate a relative displacement, according to a displacement component of the yield surface of the cohesive element, as well as controlling the mechanical behavior according to a strain softening constitutive curve, a crack can be simulated.

In an embodiment, shown in FIG. 3a, when a crack is initiated between nodes 3 and 4 in the mapping linked list relationship between the master-slave nodes, the connection between nodes 3 and 4 will be removed, and the cohesive element between nodes 3 and 4 will be activated to simulate the fracture process of the material. In the fracturing process, the yield surface of the cohesive element will have a displacement, and according to the yield surface displacement component of the cohesive element and the corresponding strain softening constitutive curve, the yield action of the crack will be simulated.

In an implementation, the step M303 in the present embodiment comprises the following steps:
Step M3031, inputting the yield surface displacement component of the cohesive element into a corresponding strain softening constitutive curve to obtain cohesive element stress;
Step M3032, obtaining an equivalent force on relevant nodes of the cohesive element according to the cohesive element stress to simulate the yield behavior of the crack.

Specifically, after the cohesive element is activated, the mechanical behavior of the cohesive element is controlled by the traction-separation law. During the strain softening phase, two edges (that is, the yield surface) of the cohesive element may generate a relative displacement. Through the yield surface displacement component of the cohesive element, the crack is simulated according to the strain softening constitutive curve. A principle of determining the softening process is that, a fracture energy of the yield surface and the yield surface displacement component have the following relationship. Specifically, defining a separation vector δ of a relative displacement of its two edges at any point is given by:
δ=δₙn+δₜt, where n and t are the normal unit vector and tangential unit vector respectively with respect to the yield surface; δₙ and δₜ are the normal and tangential separations at any point on the yield surface, respectively.

A local traction vector p may be expressed as

p=σn+τt, wherein σ and τ are the normal stress and tangential stress in the direction of n and t, respectively.

Based on the strain-softening law, the interfacial potential is defined as a function of the separation vector components:

$$p = ∇ φ ( {δ}_{n} , {δ}_{t} ) = \frac{\partial φ}{\partial {δ}_{n}} n + \frac{\partial φ}{\partial {δ}_{t}} t .$$

The interfacial potential can be further simplified as a function of an intermediate variable δ=\sqrt{δₙ²+δₜ²}, thus

$$p = ∇ φ ( δ ) = ( \frac{\partial δ}{\partial {δ}_{n}} n + \frac{\partial δ}{\partial {δ}_{t}} t ) f ( δ ) ,$$

where

$$f ( δ ) = \frac{d φ ( δ )}{d δ}$$

represents the shape of the strain-softening curve, which could be determined by laboratory experiments.

Based on the principle stated above, in the present embodiment, A variable d is defined at each integration point to characterize the damage evolution associated with the yield surface, i.e.,

$$d = min ( \sqrt{{( \frac{{δ}_{n}}{{δ}_{nc}} )}^{2} + {( \frac{{δ}_{t}}{{δ}_{tc}} )}^{2}} , 1 )$$

wherein δ_{nc} and δ_{tc} are the maximum tensile and shear separations, respectively. If the integration points on a cohesive element are completely damaged when d=1, a crack is generated.

For a tensile fracture, it is possible to obtain that:

σ=z(d)fₜ, where, fₜ is the tensile strength of the material of the two-dimensional solid, z(d) represents the strain softening function:

$$z ( d ) = [ 1 - \frac{A + B - 1}{A + B} exp ( d \frac{A + CB}{( A + B ) ( 1 - A - B )} ) ] \times$$

$$[ A ( 1 - d ) + {B ( 1 - d )}^{C} ] ( 0 \leq d \leq 1 )$$

wherein A, B and C are intrinsic rock parameters that determine the shapes of the strain-softening curve.

Thus, an I-type tensile failure fracture energy G_{f1} may be expressed as:

$${G}_{f 1} = {\int }_{0}^{{δ}_{nc}} σ d {δ}_{n} .$$

For a shear failure, it is possible to adopt the following formula and obtain a tangential stress and an II-type shear failure fracture energy G_{f2} by

$$τ = z ( d ) {f}_{s}$$

G_{f2}=∫₀^{δ}^{_{tc}} τ dδₜ, where fₛ is the anti-shear strength of the material of the two-dimensional solid.

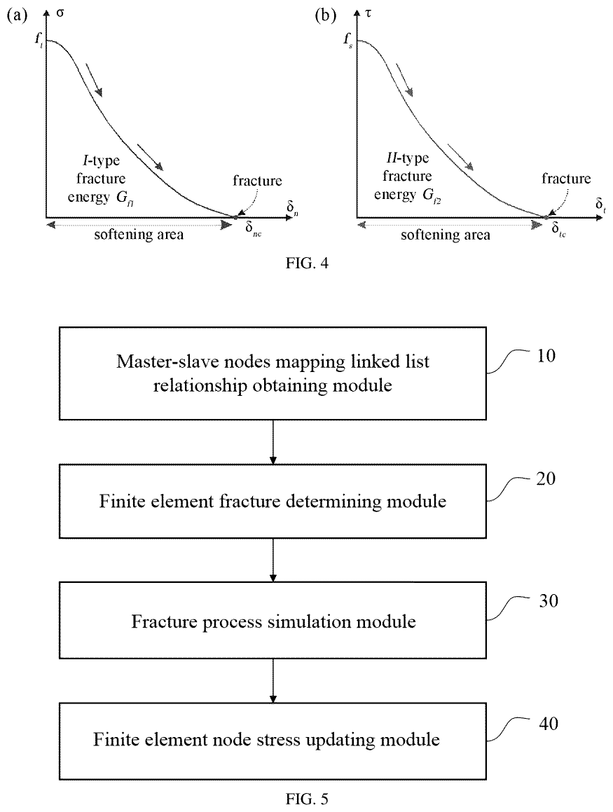

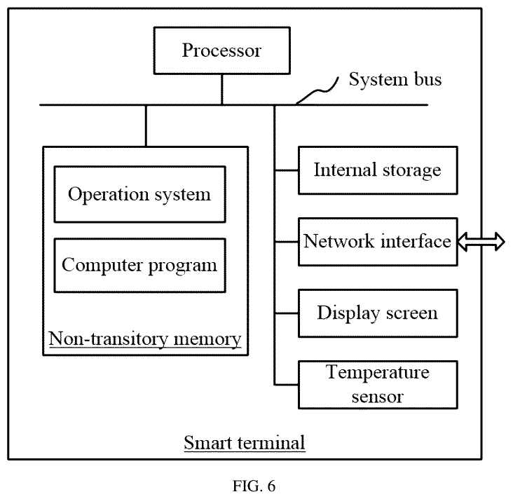

Finally, shown in FIG. 4, taking a normal separation number δₙ on the yield surface as a horizontal axis, and an anti-tensile strength fₜ as a vertical axis, before drawing a strain-softening constitutive curve on the tensile failure according to a variation curve on the I-type tensile failure fracture energy. Taking a tangent separation number δₜ on the yield surface as a horizontal axis, and an anti-shear strength fₛ as a vertical axis, before drawing a strain softening constitutive curve on the shear failure according to a variation curve on the II-type tensile failure fracture energy, it is possible to obtain a complete strain softening constitutive curve of the cohesive element. Here, FIG. 4a shows a strain softening constitutive curve on the tensile failure, and FIG. 4b shows a strain softening constitutive curve on the shear failure.

When the cohesive element is in a fully damaged state, i.e., a crack is completely generated, the calculation of the node force related to the cohesive element is stopped, and the edges of both sides of the cohesive element are marked as boundaries. If the calculation of a cohesive element is stopped, to prevent mutual embedding and shearing slippage between the crack surfaces, a contact detection and contact interaction algorithm is adopted to capture the mechanical feature between the crack surfaces.

Step S400, according to the updated mapping linked list relationship between the master-slave nodes, accumulating node forces and masses of the slave nodes onto the master node, updating the velocity and displacement of the master-slave nodes by adopting a governing equation, and re-executing the step of determining whether the crack is initiated according to whether the local stress of the finite element satisfies a strength criterion, until a simulation is completed, and ending a calculation.

Specifically, a master node parameter comprises a master node force and a master node mass, which is integrated by the node forces and the node masses of all nodes on a mapping linked list relationship between the master-slave nodes. After each iteration, by inheriting a plurality of parameters of the master node i, it decides the velocity and the displacement of the node on the mapping linked list relationship between the master-slave nodes, and re-executes the step of determining whether the mapping linked list relationship between the master-slave nodes is broken according to the node force of the mapping linked list relationship between the master-slave nodes, so as to perform a next iteration.

In an implementation, the step S400 of the present embodiment comprises the following steps:
Step S401, accumulating the node forces and the masses of the slave nodes onto the master node according to the updated mapping linked list relationship between the master-slave nodes, to obtain the node force of the master node and the mass of the master node;
Step S402, updating the velocity and the displacement of the master node through an explicit integration and a central difference algorithm, according to the node force of the master node and the mass of the master node;
Step S403, obtaining the velocity and displacement of the slave nodes corresponding to the master node according to the updated velocity and displacement of the master node.

Specifically, firstly, accumulating before obtaining the node force and the node mass of the master node according to the node force and the node masses of the nodes comprised in the mapping linked list relationship between the master-slave nodes. Obtaining the acceleration and velocity of the master node according to the node force and the node mass of the master node, wherein the acceleration of the master node may be determined by Newton's second law, and the velocity of the master node may be updated by using a center difference method. It is possible to obtain the displacement of the master node according to the velocity of the master node, since the master node has the same coordinate as the node comprised in a corresponding mapping linked list relationship between the master-slave nodes, and they are bound together, so that the master-slave node in a same mapping linked list relationship between the master-slave node share the coordinate and the displacement. Therefore, according to the acceleration and the velocity of the master node, the velocity and the displacement of all slave nodes on the mapping linked list relationship between the master-slave nodes can be obtained. According to Newton's second law, the node force of the slave node contained in the mapping linked list relationship between the master-slave nodes can be obtained by applying a deformation gradient, that is, a local stress of the finite element.

In an embodiment, during a simulation process, shown in FIG. 3a, in the mapping linked list relationship between the master-slave nodes, after calculating and obtaining the node force and the node mass of each finite element, the node forces and the node masses from the nodes 0 to 5 are all integrated onto the master node i. The acceleration of the master node i can be determined by Newton's second law, and the velocity thereof can be updated by using a central difference method. After each iteration, by inheriting the node velocity, the acceleration and the displacement of the master node i, the velocity, the acceleration and the displacement of the slave nodes 0 to 5 are updated. In an embodiment, for example, if the node velocity of the master node i is 5 m/s, and current coordinates are (n, m), the node velocity of the slave nodes from 0 to 5 is also 5 m/s, and current coordinates are also (n, m). Then, according to Newton's second law, a stress value from the slave nodes 0 to 5 is obtained to perform the next iteration.

### Embodiments on the Apparatus

Further, the present application further provides a two-dimensional continuous-discontinuous combined solid fracturing simulation apparatus, a principle block diagram is shown in FIG. 5. The apparatus comprises:
a master-slave node mapping linked list relationship obtaining module 10, configured to obtain a two-dimensional solid, and discretizing the two-dimensional solid into a plurality of finite elements to obtain a mapping linked list relationship between master-slave nodes;
a finite element fracture determining module 20, configured to determine whether a crack is initiated, according to whether local stress of the finite element satisfies a strength criterion;
a fracturing process simulation module 30, configured to update the mapping linked list relationship between the master-slave node and obtaining an updated mapping linked list relationship between the master-slave nodes, while activating a corresponding cohesive element if the crack is initiated;
a finite element node force updating module 40, configured to accumulate node forces and masses of the slave nodes onto the master node according to the updated mapping linked list relationship between the master-slave nodes, updating the velocity and a displacement of the master-slave nodes by adopting a governing equation, and re-executing the function of the finite element fracture determining module, until a simulation is completed, and ending a calculation.

In an implementation, the master-slave node mapping linked list relationship obtaining module 10 in the present embodiment comprises:
a finite element meshing unit, configured to mesh the two-dimensional solid into a plurality of finite elements;
a finite elements discretization unit, configured to discretize the finite elements, connecting adjacent finite elements through the cohesive elements, and mapping each corresponding finite element node into an independent slave node;
a master-slave node mapping linked list relationship obtaining unit, configured to bind the slave nodes to a corresponding master node by adopting a node binding scheme, and connecting the slave nodes sequentially to obtain the mapping linked list relationship between the master-slave nodes.

In an implementation, the finite element fracture determining module 20 in the present embodiment further comprises:
a local stress calculation unit, configured to calculate the local stress of the finite element according to a deformation gradient and a constitutive equation of the finite element;
a crack initiation judgment unit, configured to determine that a tensile crack will be initiated if the local stress of the finite element reaches the tensile strength; and determining that a shear crack will be initiated if the local stress of the finite element reaches the shear strength; determining that no crack is initiated if the local stress of the finite element does not reach the tensile strength or the shear strength.

In an implementation, the fracture process simulation module 30 in the present embodiment comprises:
a node relationship deletion unit, configured to delete the connection between two adjacent slave nodes if a crack is initiated;
a master-slave node mapping linked list relationship updating unit, configured to re-obtain a new master node for each of the slave nodes, and connecting the slave nodes having existing connection sequentially to obtain an updated master-slave node mapping linked list relationship;
a cohesive element activation unit, configured to activate the pre-embedded cohesive element in the crack to obtain a yield surface displacement component of the cohesive element;
a cohesive element strain softening unit, configured to simulate the yield behavior of the cohesive element according to the yield surface displacement component of the cohesive element and a corresponding strain softening constitutive curve.

In an implementation, the cohesive element strain softening unit in the present embodiment comprises:
a cohesive element stress obtaining subunit, configured to input the yield surface displacement component of the cohesive element into a corresponding strain softening constitutive curve to obtain cohesive element stress;
a crack simulation subunit, configured to obtain an equivalent force on a relevant node of the cohesive element according to the cohesive element stress to simulate the yield behavior of the crack.

In an implementation, the finite element node force updating module 40 comprises:
a node force obtaining unit for the master node, configured to accumulate the node forces and masses of the slave nodes onto the master node according to the updated mapping linked list relationship between the master-slave nodes, to obtain the node force of the master node and mass of the master node;
a velocity and displacement obtaining unit for the master node, configured to update the velocity and displacement of the master node through an explicit integration and a central difference scheme, according to the node force of the master node and the mass of the master node;
a velocity and displacement obtaining unit for the slave nodes, configured to obtain the velocity and a displacement of the slave nodes corresponding to the master node according to the updated velocity and the updated displacement of the master node.

Based on the embodiments stated above, the present application further provides a smart terminal, wherein the smart terminal comprises a memory, a processor, and a two-dimensional continuous-discontinuous combined solid fracturing simulation program stored in the memory and capable of being run by the processor. When the processor runs the two-dimensional continuous-discontinuous combined solid fracturing simulation program, a plurality of steps on the two-dimensional continuous-discontinuous combined solid fracturing simulation method, as described by anyone of the items above, is implemented.

A person of ordinary skill in the art may understand that all or some of the processes in the method stated in the embodiments above may be implemented by a computer program instructing a plurality of related hardware, and the computer program may be stored in a non-volatile computer-readable storage medium. When executed, the computer program may comprise a flow of an embodiment of the methods stated above. Any references to the memory, the storage, the operation databases, or other media used in the embodiments provided in the present application may comprise a non-volatile memory and/or a volatile memory. The non-volatile memory may comprise a read-only memory (ROM), a programmable ROM (PROM), an electrically programmable ROM (EPROM), an electrically erasable programmable ROM (EEPROM), or a flash memory. The volatile memory may comprise a random access memory (RAM) or an external cache. By way of an illustration, instead of a limitation, the RAM may be available in various forms, including static RAM (SRAM), dynamic RAM (DRAM), synchronous DRAM (SDRAM), dual operational data rate SDRAM (DDRSDRAM), enhanced SDRAM (ESDRAM), Synchlink DRAM (SLDRAM), memory bus (RAMBUS) direct RAM (RDRAM), direct memory bus dynamic RAM (DRDRAM), memory bus dynamic RAM (RDRAM), and more.

All of the above, the present application discloses a two-dimensional continuous-discontinuous combined solid fracturing simulation method, which comprises: discretizing the two-dimensional solid into a plurality of finite elements to obtain a mapping linked list relationship between master-slave nodes; determining whether a crack is initiated according to whether the local stress of the finite element satisfies a strength criterion; if the crack is initiated, activating a corresponding pre-embedded cohesive element and embedding a yield surface, while updating the mapping linked list relationship between the master-slave nodes at the same time; according to the mapping linked list relationship between the master-slave nodes, accumulating the node forces and masses of the slave nodes onto the master node, updating the velocity and displacement of the master-slave nodes by adopting a governing equation. The present application can not only ensure that the two-dimensional solid is fully continuous prior to fracture onset, but also avoids the numerical instability issues caused by local node splitting when cracks occur, thus improving computational efficiency.

It should be understood that the present application is not limited to the above examples listed. Ordinary technical personnel in this field can improve or change the applications according to the above descriptions. All of these improvements and transforms should belong to the scope of protection in the appended claims of the present application.

1-10. (canceled)

11. A two-dimensional continuous-discontinuous combined solid fracturing simulation method, comprising:
obtaining a two-dimensional solid, and discretizing the two-dimensional solid into a plurality of finite elements to obtain a mapping linked list relationship between master-slave nodes;
determining whether a crack is initiated according to whether local stress of the finite element satisfies a strength criterion;
updating, if the crack is initiated, the mapping linked list relationship between the master-slave nodes, obtaining an updated mapping linked list relationship between the master-slave nodes, activating a corresponding pre-embedded cohesive element, and controlling a mechanical behavior of the cohesive element by adopting a strain softening constitutive curve; and
accumulating, according to the updated mapping linked list relationship between the master-slave nodes, node forces and masses of the slave nodes onto the master node, updating velocity and displacement of the master-slave nodes by adopting a governing equation, and re-executing the step of determining whether the crack is initiated according to whether the local stress of the finite element satisfies a strength criterion, until a simulation is completed, and ending a calculation.

12. The method according to claim 11, wherein discretizing the two-dimensional solid into the finite elements to obtain the mapping linked list relationship between the master-slave nodes comprises:
dividing the two-dimensional solid into a plurality of finite elements;
discretizing the finite elements, connecting adjacent finite elements through the cohesive elements, and mapping each corresponding finite element node into an independent slave node; and
binding the slave nodes to a corresponding master node by adopting a node binding scheme, and connecting the slave nodes sequentially to obtain the mapping linked list relationship between the master-slave nodes.

13. The method according to claim 11, wherein determining whether the crack is initiated according to whether the local stress of the finite element satisfies the strength criterion comprises:
calculating the local stress of the finite element according to a deformation gradient and a constitutive equation of the finite element;
determining that the finite element has a tensile crack initiated if the local stress of the finite element reaches a tensile strength;
determining that the finite element has a shear crack initiated if the local stress of the finite element reaches a shear strength; and
determining that no crack is initiated if the local stress of the finite element does not reach the tensile strength or the shear strength.

14. The method according to claim 11, wherein updating, if the crack is initiated, the mapping linked list relationship between the master-slave nodes and obtaining the updated mapping linked list relationship between the master-slave nodes comprises:
removing a connection between two adjacent slave nodes at the crack if the crack is initiated; and
re-obtaining a new master node for each of the slave nodes, and connecting the slave nodes having existing connections sequentially to obtain the updated master-slave node mapping linked list relationship.

15. The method according to claim 11, wherein activating the pre-embedded cohesive element in the crack, and controlling the mechanical behavior of the cohesive element by adopting the strain softening constitutive curve comprises:
activating the pre-embedded cohesive element in the crack, to obtain a yield surface displacement component of the cohesive element; and
simulating a yield behavior of the crack according to the yield surface displacement component of the cohesive element and the corresponding strain softening constitutive curve.

16. The method according to claim 15, wherein simulating the yield behavior of the cohesive element according to the yield surface displacement component of the cohesive element and a strain softening constitutive curve comprises:
inputting the yield surface displacement component of the cohesive element into the corresponding strain softening constitutive curve to obtain a cohesive element stress; and
obtaining an equivalent force on a relevant node of the cohesive element according to the cohesive element stress to simulate a yield behavior of the crack.

17. The method according to claim 14, wherein accumulating the node forces and masses of the slave nodes onto the master node according to the updated mapping linked list relationship between the master-slave nodes, and updating the velocity and displacement of the master-slave nodes through the governing equation comprises:
accumulating the node forces and masses of the slave nodes onto the master node according to the updated mapping linked list relationship between the master-slave nodes to obtain a node force of the master node and a mass of the master node;
updating the velocity and the displacement of the master node through an explicit integration and a central difference scheme, according to the node force of the master node and the mass of the master node; and
obtaining the velocity and the displacement of the slave nodes corresponding to the master node according to the updated velocity and updated displacement of the master node.

18. A two-dimensional continuous-discontinuous combined solid fracturing simulation apparatus, comprising:
a master-slave node mapping linked list relationship obtaining module, configured to obtain a two-dimensional solid and discretizing the two-dimensional solid into a plurality of finite elements, to obtain a mapping linked list relationship between master-slave nodes;
a finite element fracture determining module, configured to determine whether a crack is initiated, according to whether the local stress of the finite element satisfies a strength criterion;
a fracturing process simulation module, configured to update the mapping linked list relationship between the master-slave nodes, obtaining an updated mapping linked list relationship between the master-slave nodes, activating a corresponding pre-embedded cohesive element, and controlling a mechanical behavior of the cohesive element by adopting a corresponding strain softening constitutive curve, if the crack is initiated; and
a finite element node force updating module, configured to accumulate node forces and masses of the slave nodes onto the master node according to the updated mapping linked list relationship between the master-slave nodes, updating the velocity and the displacement of the master-slave nodes by adopting a governing equation, and re-executing the function of the finite element fracture determining module, until a simulation is completed, and ending a calculation.

19. A smart terminal, wherein the smart terminal comprises a memory, a processor, and a two-dimensional continuous-discontinuous combined solid fracturing simulation program stored in the memory and capable of being run by the processor, and when the processor runs the two-dimensional continuous-discontinuous combined solid fracturing simulation program, a plurality of steps on the two-dimensional continuous-discontinuous combined solid fracturing simulation method according to claim 1 is implemented.
